(19) United States
(12) Patent Application Publication
(10) Pub. No.: US 2012/0099612 A1
(43) Pub. Date: Apr. 26, 2012

(54) BANDWIDTH NARROWING MODULE FOR SETTING A SPECTRAL BANDWIDTH OF A LASER BEAM

(75) Inventors: Markus Deubel, Aalen (DE); Anton Lengel, Oberkochen (DE)

(73) Assignee: CARL ZEISS LASER OPTICS GMBH, Oberkochen (DE)

(21) Appl. No.: 13/238,470

(22) Filed: Sep. 21, 2011

Related U.S. Application Data
(63) Continuation of application No. PCT/EP2010/002722, filed on May 4, 2010.
(60) Provisional application No. 61/176,545, filed on May 8, 2009.

(30) Foreign Application Priority Data
May 8, 2009 (DE) 10 2009 020 501.2

(51) Int. Cl. H01S 3/10

(52) U.S. Cl. 372/26

(57) ABSTRACT

The disclosure provides a bandwidth narrowing module for setting a spectral bandwidth of a laser beam of a laser light source. The bandwidth narrowing module includes a beam expanding module for expanding a laser beam transversely with respect to a propagation direction of the laser beam and comprising a reflection grating. A first optical component of the bandwidth narrowing module is configured so that a disturbance with a cylindrical portion about a first axis transversely with respect to an optical axis of the bandwidth narrowing module can be impressed on a wavefront of a laser beam. The first optical component is embodied such that it is pivotable about a pivoting axis parallel to the first axis.

### CROSS-REFERENCE TO RELATED APPLICATIONS

This application is a continuation of, and claims benefit under 35 USC 120 to, international application PCT/EP2010/002722, filed May 4, 2010, which claims benefit under 35 USC 119 of German Application No. 10 2009 020 501.2, filed May 8, 2009 and under 35 USC 119(e) of U.S. Ser. No. 61/176,545, filed May 8, 2009. International application PCT/EP2010/002722 is hereby incorporated by reference in its entirety.

### FIELD

The disclosure relates to a bandwidth narrowing module for setting a spectral bandwidth of a laser beam of a laser light source. The bandwidth narrowing module includes a beam expanding module for expanding a laser beam transversely with respect to a propagation direction of the laser beam and including a reflection grating. A first optical component of the bandwidth narrowing module is configured so that a disturbance with a cylindrical portion about a first axis transversely with respect to an optical axis of the bandwidth narrowing module can be impressed on a wavefront of a laser beam. The disclosure also relates to a laser light source.

### BACKGROUND

A bandwidth narrowing module for setting a spectral bandwidth of a laser beam of a laser light source is generally used in laser light sources which are used for semiconductor lithography or for laser material processing. Excimer lasers, in particular, are used for semiconductor lithography. The lasers, without an additional device for bandwidth narrowing, have a spectral bandwidth of approximately 0.5 nm (nanometer). This bandwidth is usually too great for the use of such lasers as light sources in semiconductor lithography. Therefore, in lasers used as a light source for semiconductor lithography, so-called bandwidth narrowing modules are employed, which reduce the bandwidth.

Such a bandwidth narrowing module includes an input aperture, a beam expanding module and a reflection grating, wherein the bandwidth narrowing module replaces one of the two end mirrors of the laser resonator. Laser light incident in the bandwidth narrowing module is reflected back into the resonator via the reflection grating, which is arranged in a Littrow arrangement, for example, through the input aperture only when the wavelength of the light satisfies the grating equation. Which wavelength is reflected back into the resonator depends on the angles at which the light is incident on the grating. The greater the angle distribution of the incident light, the greater the width of the wavelength distribution and hence the spectral bandwidth of the useful beam of the laser beam which leaves the laser resonator. The generation of laser radiation with a small bandwidth therefore involves a small angle distribution (narrow angle spectrum) within the laser beam.

A smaller angle distribution within the laser beam can be achieved by the laser beam that is incident in the bandwidth narrowing module from the resonator being expanded with the aid of a beam expanding module in a direction transversely with respect to the propagation direction of the laser beam. In this case, the expansion of the laser beam can be 20 to 50 times the laser beam incident in the bandwidth narrowing module. Spectral bandwidths of the laser beam of a few 100 fm (femtometers) can thereby be achieved. Greater beam expansion accordingly leads to a smaller spectral bandwidth of the laser light.

While laser light having a smallest possible spectral bandwidth is desired for semiconductor lithography, for other applications it is sometimes desirable, however, to artificially increase the spectral bandwidth of the laser light, for example in order to use a laser that provides only a small spectral bandwidth as a light source for a process which involves a higher spectral bandwidth of the laser light or which has been optimized for laser light having a greater spectral bandwidth.

One possibility for artificially increasing the spectral bandwidth is to reduce the abovementioned beam expansion of the laser beam. In the case of a bandwidth narrowing module having a beam expanding module with a plurality of prisms, this can be realized by rotating one of the prisms in order to reduce the beam expansion and thereby to increase the spectral bandwidth.

### SUMMARY

The disclosure provides a bandwidth narrowing module that includes an alternative mechanism for setting a spectral bandwidth of a laser beam.

According to the disclosure, a first optical component of the bandwidth narrowing module is embodied such that it is pivotable about a pivoting axis parallel to the first axis.

In this context, a “disturbance of a wavefront” should be understood to mean an alteration of the wavefront of a laser beam upon passing through the first optical component. In this case, the alteration is effected in such a way that the wavefront, after passing through the first optical component, has a form that differs from the form of the wavefront upstream of the first optical component by virtue of an additional cylindrical portion about a first axis transversely with respect to an optical axis of the bandwidth narrowing module. A disturbance with a cylindrical portion or a second- and/or higher-order disturbance is thus impressed on the wavefront. The disturbance of the wavefront that is generated by the first optical component results in additionally introduced angles in an angle spectrum of the laser light, which are in turn translated into different wavelengths at the downstream reflection grating and thus lead to an increased spectral bandwidth of the laser light. The first axis can, in particular, also be arranged parallel to grating lines of the reflection grating. Via the present disclosure, an already existing laser light source can be retrofitted by inserting an additional first optical component or by replacing an existing optical component by a correspondingly modified component for the targeted influencing of the spectral bandwidth of the laser beam. In the case of the disclosure, it is furthermore advantageous that a spectral bandwidth of the laser beam can be varied by pivoting the first optical component during operation or within a short conversion time in order to use the laser light thus generated for different processes for example in semiconductor lithography.

In one configuration of the disclosure, the first optical component is embodied as a first prism of the beam expanding module. In this case, the first prism is modified in such a way that it is possible to produce a disturbance of the wavefront with a cylindrical portion about a first axis transversely with respect to an optical axis of the bandwidth narrowing module. As already explained, beam expansion and hence an increase in the spectral bandwidth of the bandwidth narrowing module can be obtained by pivoting the prism. In this case, the pivoting axis of the first prism is preferably oriented at least approximately parallel to a longitudinal axis of the first prism. As a result of a modification and configuration of the prism as a first optical component, it is possible, via the prism, to impress on the wavefront a disturbance with a cylindrical portion about a first axis transversely with respect to an optical axis of the bandwidth narrowing module, which alters as a result of rotation, which contributes to a further increase in the spectral bandwidth of the laser beam. Overall, a setting range of the spectral bandwidth is thus increased.

In a further configuration of the disclosure, an entrance surface and/or an exit surface of the first prism is configured as a cylindrical profile at least in sections. A cylindrical disturbance can thereby be impressed on the wavefront in a simple manner.

In a further configuration of the disclosure, the first optical component, at least in sections, has a cylindrical form and is arranged between beam expanding module and reflection grating. In this configurational form, the first optical component can particularly easily be retrofitted or inserted into the laser beam.

In a further configuration of the disclosure, the first optical component is configured as a cylindrical lens or cylindrical mirror. A cylindrical disturbance can thereby be impressed on the wavefront.

In a further configuration of the disclosure, a second optical component of the bandwidth narrowing module is configured and arranged in the bandwidth narrowing module in such a way that a wavefront disturbance produced by the first optical component can be at least partly compensated for. The at least partial compensation of the disturbance by the second optical component has the consequence that the form of the wavefront after passing through the second optical component is again approximated to the form of the wavefront upstream of the first optical component. For this purpose, a focal length of the second optical component preferably has an opposite sign to a focal length of the first optical component. Without restricting the generality, the wavefront after passing through the second optical component can also have a form identical to that upstream of the first optical component. In this case, the first optical component and the second optical component can be arranged as additional, separate components at any desired location within the bandwidth narrowing module or within the beam expanding module. Equally, however, it is also possible to modify components of the bandwidth narrowing module which are already present and can be utilized for other purposes, such that with their aid, in addition to their original function, a disturbance of the wavefront with a cylindrical portion can be produced (first optical component) and can respectively be at least partly compensated for again (second optical component). Without restricting the generality, it is also possible for one of the two optical components to be embodied as an additional component and for the other optical component to be embodied as a modification of an existing component of the bandwidth narrowing module or of the beam expanding module. A spectral bandwidth of the laser beam can be set by pivoting of the first optical component.

In a further configuration of the disclosure, the second optical component is arranged in displaceable fashion in the bandwidth narrowing module. Depending on the configuration of the second optical component, it is advantageous to configure the second optical component such that it is displaceable translationally and/or displaceable rotationally (that is to say rotatable or pivotable). In the case of a configuration of the second optical component as a separate, additional component, the second optical component can also be embodied such that it can be introduced into the laser beam and removed again. In this case, it is advantageous that compensation of the disturbed wavefront can be set with the aid of the second optical component. This affords a further possibility of varying a spectral bandwidth of the laser beam during operation or within a short conversion time in order to use the laser light thus generated for different processes for example in semiconductor lithography.

In a further configuration of the disclosure, the second optical component is embodied as a second prism of the beam expanding module. In this case, the second prism is modified in such a way that the disturbance of the wavefront produced by the first optical component can be at least partly compensated for. In this case, a pivoting axis of the second prism is preferably oriented at least approximately parallel to a longitudinal axis of the second prism. By using a second prism of the beam expanding module as a second optical component, the number of components overall for realizing the present disclosure is reduced.

In a further configuration of the disclosure, an entrance surface and/or an exit surface of the second prism is configured as a cylindrical profile at least in sections. In particular, cylindrical disturbance of the wavefront can thereby be at least partly compensated for simply and effectively.

In a further configuration of the disclosure, the second optical component, at least in sections, has a cylindrical form and is arranged between beam expanding module and reflection grating. In this configurational form, the second optical component can particularly easily be retrofitted or inserted into the laser beam.

In a further configuration of the disclosure, the second optical component is configured as a cylindrical lens or cylindrical mirror. A cylindrical disturbance impressed on the wavefront by the first optical component can thereby be compensated for in a simple manner.

In one configuration of the disclosure, the reflection grating is configured as a second optical component. The disturbance of the wavefront that is generated by the first optical component results in additional introduced angles in an angle spectrum of the laser light, which are in turn translated into different wavelengths at the downstream reflection grating and thus lead to an increased spectral bandwidth of the laser light. By using a reflection grating, which can be embodied in a Littrow arrangement, for example, as a second optical component, the number of components for realizing the disclosure is reduced.

In a further configuration of the disclosure, the reflection grating is embodied in curved fashion. In this way, a cylindrical disturbance of the wavefront that is introduced by the first optical component can be at least partly reduced effectively.

In a further configuration of the disclosure, an approach is provided which can be used to set a curvature of the reflection grating. It is advantageous in this case that a degree of compensation of the wavefront disturbance and hence a spectral bandwidth of the laser beam can be set during operation.

According to the disclosure, a laser light source is furthermore provided, which emits light having a wavelength λ₀, lying in a range of approximately 140 nanometers to approximately 380 nanometers, and having a wavelength spectrum of a bandwidth Δλ around the wavelength λ₀, wherein the bandwidth Δλ can be set.

In preferred configurations, the wavelength λ₀ is approximately 157 nanometers, approximately 193 nanometers, approximately 248 nanometers or approximately 308 nanometers.

With the wavelengths λ₀ mentioned above, the laser light source according to the disclosure is suitable, in particular, for use in semiconductor lithography.

In a further preferred configuration, the wavelength λ₀ is approximately 351 nm. In this configuration, the laser light source is suitable, in particular, for use in material processing, in particular for the crystallization of silicon wafers.

According to the disclosure, a laser light source is furthermore provided, which emits light having a wavelength λ₀ and a wavelength spectrum of a bandwidth Δλ around the wavelength λ₀ with a power in a power range of approximately 20 to approximately 2000 watts, wherein the bandwidth Δλ can be set.

In one preferred configuration, in which the power lies in a power range of approximately 20 to approximately 100 watts, the laser light source is suitable for use in semiconductor lithography.

In a further preferred configuration, in which the laser light source is suitable for use in material processing, in particular for the crystallization of silicon wafers, the power lies in a power range of approximately 500 to approximately 2000 watts.

According to the disclosure, a laser light source is furthermore provided, which emits light having a wavelength λ₀ and having a wavelength spectrum of a bandwidth Δλ around the wavelength λ₀ in the form of light pulses having a power in a power range lying in the range of approximately 10 millijoules per pulse to approximately 500 millijoules per pulse, wherein the bandwidth Δλ can be set.

In one preferred configuration, which is suitable for the use of the laser light source in semiconductor lithography, the power lies in a power range of approximately 10 mJ/pulse to approximately 20 mJ/pulse.

A configuration of the laser light source which is suitable for material processing, in particular for the crystallization of silicon wafers, generates a power in a power range of approximately 50 millijoules per pulse to approximately 5000 millijoules per pulse.

In all cases mentioned above, which can also be combined with one another, the bandwidth Δλ can be set in a range of approximately 100 femtometers (fm) to approximately 300 femtometers, further to approximately 400 femtometers, further preferably to approximately 500 femtometers and further to approximately 1000 femtometers.

A laser light source according to the disclosure has a bandwidth narrowing module in accordance with one or more of the configurations mentioned above.

Further advantages and features will become apparent from the following description and the accompanying drawings.

The features mentioned above and those explained below can be used not only in the respectively specified combination but also in other combinations or by themselves, without departing from the scope of the present disclosure.

### BRIEF DESCRIPTION OF THE DRAWINGS

Exemplary embodiments of the disclosure are illustrated in the drawing and are described in greater detail hereinafter with reference thereto. In the figures:

FIG. 1) shows an overview illustration of a laser light source with a bandwidth narrowing module according to the disclosure;

FIGS. 2a) and 2b) show a first exemplary embodiment of a bandwidth narrowing module with a first optical component and a second optical component in different operating positions;

FIGS. 3a) and 3b) show a second exemplary embodiment of a bandwidth narrowing module with a first optical component and a second optical component in different operating positions;

FIG. 4) shows a third exemplary embodiment of a bandwidth narrowing module according to the disclosure; and

FIG. 5) shows an exemplary embodiment of a prism of a beam expanding module.

### DETAILED DESCRIPTION

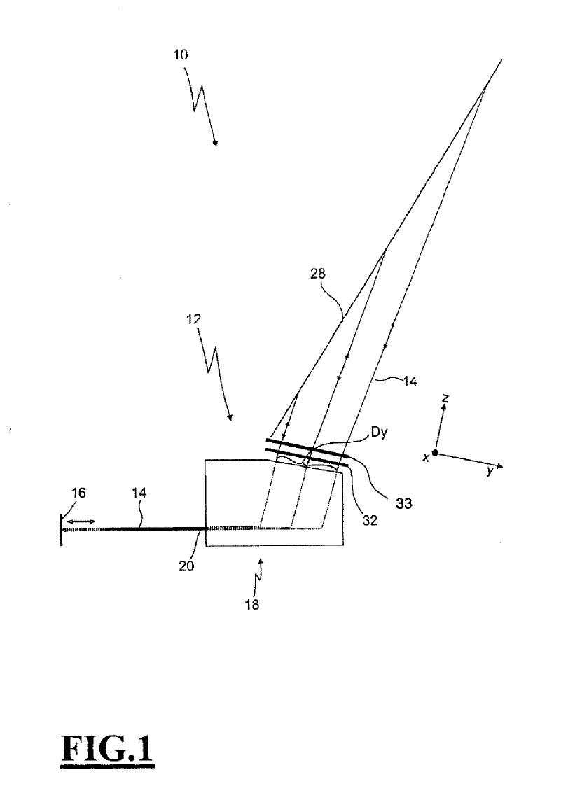

FIG. 1 illustrates an excerpt from a laser light source 10. The laser light source 10 includes a laser resonator (not illustrated in greater detail) with a laser-active medium and a bandwidth narrowing module 12, which forms an end mirror of the laser resonator of the laser light source 10. A further end mirror 16 serves as a coupling-out mirror and is correspondingly embodied in partly transmissive fashion.

The bandwidth narrowing module 12 has a beam expanding module 18 having an input aperture 20, which module can be constructed from one or a plurality of prisms. The laser beam 14 passes through the beam expanding module 18 and is expanded in the process. After leaving the beam expanding module 18, the laser beam 14 correspondingly has a larger cross section than before entering into the beam expanding module 18. After emerging from the beam expanding module 18, the laser beam 14 has a first dimension D_{y} in a first spatial direction, which is designated below by y, and a second dimension in a second spatial direction, which is designated below by x, and which is perpendicular to the first spatial direction y and runs perpendicularly to the plane of the drawing in FIG. 1, the second dimension being smaller than the first dimension D_{y} here without restricting the generality. The spatial direction of the propagation direction of the laser beam 14 is designated by z.

The bandwidth narrowing module 12 furthermore has a reflection grating 28, which is arranged in a Littrow arrangement with respect to the laser beam 14 incident on the reflection grating 28. By virtue of the Littrow arrangement of the reflection grating 28, a very high reflection order is retroreflected from the reflection grating 28 and then passes again through the beam expanding module 18 as far as the second end mirror 16.

The reflection grating 28 reflects back into the beam expanding module 18 only those wavelengths of the laser beam 14 which satisfy the grating equation. Which wavelengths are reflected back into the resonator depends on the angles at which the light of the laser beam 14 is incident on the reflection grating 28. The larger the angle spectrum of the incident light of the laser beam 14, the greater the width of the wavelength distribution and hence the bandwidth of the laser beam which is coupled out from the second mirror 16 and which leaves the laser resonator as a useful beam. The laser light source 10 thus generates a laser beam having a small spectral bandwidth if the angle distribution (angle spectrum) of the laser beam 14 incident on the reflection grating 28 is small, and a correspondingly larger spectral bandwidth if the angle distribution is correspondingly larger.

In order to enlarge the angle distribution or the angle spectrum of the laser beam, the bandwidth narrowing module 12 has a first optical component 32 and a second optical component 33, which is arranged downstream of the beam expanding module 18 in the first exemplary embodiment in accordance with FIG. 1. An angle distribution or an angle spectrum of the laser beam can be influenced with the aid of the first optical component 32. Consequently, with the first optical component 32, a disturbance of a wavefront of the laser beam can be produced, which in turn can be at least partly compensated for with the aid of the second optical component 33.

Various exemplary embodiments of the bandwidth narrowing module 12 are described in greater detail below.

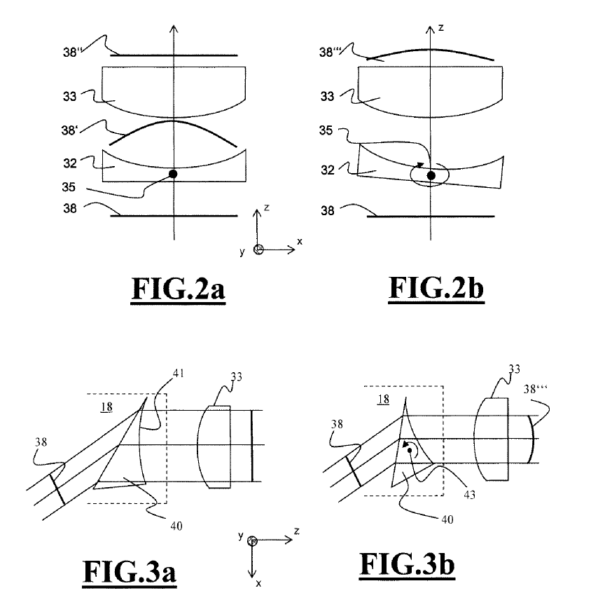

FIGS. 2a and 2b schematically illustrate an excerpt from the bandwidth narrowing module 12 with a first optical component 32 and a second optical component 33 in different operating positions. In this case, the first optical component is embodied as a planoconvex first cylindrical lens 32 and the second optical component is embodied as a planoconcave second cylindrical lens 33. In FIGS. 2a and 2b, the cylinder axes of the first cylindrical lens 32 and of the second cylindrical lens 33 are oriented parallel to one another and parallel to grating lines of the reflection grating 28.

In FIG. 2a, a disturbance with a cylindrical portion about an axis 35 transversely with respect to an optical axis z of the bandwidth module is firstly impressed on the wavefront 38 via the first cylindrical lens 32, such that the wavefront assumes a first form 38′ having a cylindrical aberration. In this exemplary embodiment, the refractive power of the first cylindrical lens 32 and the refractive power of the second cylindrical lens 33 are chosen such that the disturbance of the wavefront that is produced by the first cylindrical lens 32 is compensated for again by the second cylindrical lens 33 in the position of the cylindrical lenses 32, 33 that is shown in FIG. 2a, thus giving rise to a wavefront in a second form 38″, which is at least substantially identical to the original wavefront 38.

The arrangement shown in FIG. 2b substantially corresponds to that from FIG. 2a, but the first cylindrical lens 32 was pivoting slightly about a pivoting axis 35, which, in this exemplary embodiment, corresponds to the axis about which a disturbance with a cylindrical portion is impressed on the wavefront. Upon passing through the arrangement in accordance with FIG. 2, a disturbance of the wavefront that is produced by the first cylindrical lens 32 is only partly compensated for by the second cylindrical lens 33, such that the wavefront downstream of the arrangement assumes a third form 38″′, which is distinguished by an enlarged cylindrical aberration by comparison with the second form 38″. Consequently, a size of the resulting wavefront disturbance can be set pivoting of the first cylindrical lens 32, wherein the size of the cylindrical aberration increases as the pivoting angle of the first cylindrical lens 32 increases. If such a wavefront with a cylindrical disturbance in the third form 38″′ impinges on the reflection grating 28, that results in a larger angle spectrum at the reflection grating and thus in an increased spectral bandwidth of the reflected laser light.

Furthermore, in this exemplary embodiment as in all the subsequent exemplary embodiments, a use of cylindrical lenses which, alongside the cylindrical structure, have no or at most negligible figure errors (transmission) is advantageous. The application of an antireflection coating is advantageous in order to avoid interferences and multiple reflections.

In a modified exemplary embodiment (not illustrated), the bandwidth narrowing module according to the disclosure is configured without a second component. Compensation of a wavefront disturbance introduced by the first component is then no longer possible. A setting of the spectral bandwidth is possible by pivoting of the first component about an axis transversely with respect to an optical axis of the bandwidth narrowing module.

In a further modified exemplary embodiment, both cylindrical lenses are configured in pivotable fashion. In a further modified exemplary embodiment, the first cylindrical lens and the second cylindrical lens are shaped such that, in every possible relative position of the two lenses with respect to one another, a wavefront disturbance with a cylindrical portion can be produced, such that no position exists in which complete compensation of a wavefront disturbance produced by the first cylindrical lens is effected. It is furthermore also possible to replace the cylindrical lenses by other optical elements, for example cylindrical mirrors.

A second exemplary embodiment of a bandwidth narrowing module according to the disclosure is explained below with reference to FIGS. 3a and 3b. In the second exemplary embodiment, the first optical element is configured as a first prism 40 of a beam expanding module 18 having a concave surface 41, by which a disturbance with a cylindrical portion about an axis transversely with respect to an optical axis z of the bandwidth narrowing module can be impressed on the wavefront 38. At least partial compensation of a wavefront disturbance produced by the first prism 40 can be obtained via a planoconvex second cylindrical lens 33. In FIG. 7a, the first prism 40 and the planoconvex second cylindrical lens 33 are shown in an operating position in which a wavefront disturbance is completely compensated for by the planoconvex cylindrical lens 33, thus resulting in plane wavefronts in each case upstream of the first prism 40 and downstream of the second cylindrical lens 33.

A size of the wavefront disturbance is set by the first prism 40 being pivoted about a pivoting axis 43 oriented transversely with respect to a propagation direction of the laser beam and preferably parallel to the grating lines of the reflection grating 28. A corresponding operating position with a pivoted first prism 40 is illustrated in FIG. 3b. As a result of the pivoting of the first prism 40, a wavefront disturbance is not completely compensated for, such that the wavefront, after passing through the second cylindrical lens, has a third form 38″′ with a cylindrical profile. A fashioning of the cylindrical profile can thus be set via the pivoting angle of the first prism 40, as a result of which it is possible, in turn, to influence a spectral bandwidth of the laser light beam reflected at the reflection grating 28.

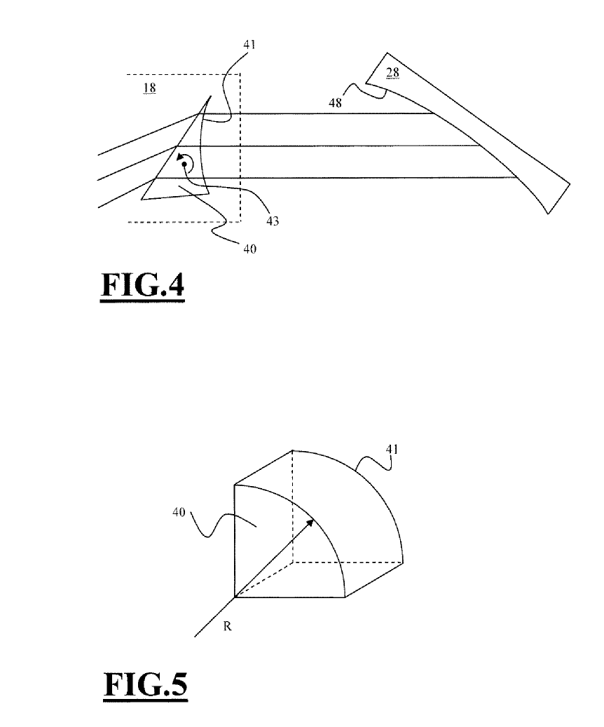

FIG. 4 illustrates a third exemplary embodiment of a bandwidth narrowing module according to the disclosure. In this exemplary embodiment, the first optical component is embodied as a first prism 40 of a beam expanding module 18 having a concave surface on a side 41. Analogously to the second exemplary embodiment, the first prism 40 can be pivoted about a pivoting axis 43 oriented transversely with respect to a propagation direction of the laser beam and preferably parallel to the grating lines of the reflection grating 28. The second optical component is embodied as a reflection grating 28 having a curved reflective surface 48. The bandwidth of the laser light beam reflected at the reflection grating 28 can be set by the first prism 40 being pivoted about the pivoting axis 43, by which an effective cylindrical aberration is impressed on the wavefront, the aberration being translated into an increased bandwidth at the reflection grating. In this case, a size of the cylindrical aberration and hence the bandwidth can be set by the pivoting angle. In this embodiment, the small number of components for realizing a setting of the spectral bandwidth is advantageous. A curvature of the reflection grating 28 can preferably be set by a suitable mechanism.

An exemplary embodiment of a first prism 40 of the beam expanding module 18 which is suitable for modification of a wavefront is illustrated in FIG. 5. In this exemplary embodiment, the first prism 40 has a convexly configured hypotenuse with a radius R of curvature of 10 meters. In an operating position of the bandwidth narrowing module which is designed for maximum beam expansion, a cylindrical aberration impressed by the first prism can be at least partly compensated for by a correspondingly adapted second prism of the beam expanding module (for example having a concave surface) or by an adapted, for example concavely curved, reflection grating 28 or by an additional second optical component 33 having a concave surface in the laser beam. As a result of the pivoting of the first prism 40, firstly a beam expansion is altered and, in addition, a cylindrical aberration is impressed on the wavefront. In this way, by pivoting, a beam expansion can be reduced and, at the same time, an additional angle can be produced via impression of a corresponding wavefront disturbance. In this way, by pivoting of the first prism 40, it is possible to obtain a larger spectral bandwidth than would be the case via beam expansion using a conventional prism having planar surfaces alone.

In a modified exemplary embodiment (not illustrated), a first component is embodied as a prism of the beam expanding module, in which both an entrance surface and an exit surface are configured with a cylindrical profile. By way of example, the entrance surface can be provided with a cylindrically concave profile and the exit surface can be provided with a cylindrically convex profile, or vice versa. In an exemplary embodiment modified further, the cylindrical profiles of the entrance surface and of the exit surface are chosen such that a cylindrical disturbance of the wavefront that is impressed by the entrance surface can be compensated for by the exit surface in a first operating position of the prism. When the prism is pivoted into a second operating position, owing to the refraction an angle of incidence at the entrance surface changes to a greater extent than an angle of emergence at the exit surface, such that a cylindrical disturbance of the wavefront that is impressed by the entrance surface is no longer compensated for to the same extent as in the first operating position of the prism.

In all the exemplary embodiments, it is possible to set a bandwidth of the laser beam by impressing a disturbance with a cylindrical portion about a first axis transversely with respect to an optical axis of the bandwidth narrowing module on a wavefront of the laser along an effective direction of the reflection grating.

The first optical component 32 and/or the second optical component 33 is produced from CaF₂, in particular, if the central wavelength of the laser light is less than 200 nm.

The laser light source 10 having a variable setting range of the spectral bandwidth Δλ can be designed such that it emits light having a wavelength λ₀ in a range of approximately 140 nanometers to approximately 380 nanometers, for example light having a wavelength λ₀ of approximately 157 nanometers, of approximately 193 nanometers, approximately 248 nanometers, approximately 308 nanometers or approximately 351 nanometers.

The power of the light emitted by the laser light source 10 can lie in the range of approximately 20 to approximately 2000 watts, preferably in the range of approximately 20 to approximately 100 watts or in the range of approximately 500 to approximately 2000 watts.

The laser light source 10 can also emit pulsed light in the form of light pulses having a power lying in the range of approximately 10 millijoules per pulse to approximately 500 millijoules per pulse, preferably in the range of approximately 10 millijoules per pulse to approximately 20 millijoules per pulse or in the range of approximately 50 millijoules per pulse to approximately 5000 millijoules per pulse.

The setting range of the spectral bandwidth Δλ can be settable in the range of approximately 100 femtometers to approximately 300 femtometers, of approximately 100 femtometers to approximately 400 femtometers or even of approximately 100 femtometers to approximately 500 femtometers or more.

What is claimed is:

1. A bandwidth narrowing module, comprising:
a beam expanding module configured to expand a laser beam transversely with respect to a propagation direction of the laser beam;
a reflection grating;
a first optical component; and
a second optical component,
wherein:
the first optical component is configured so that a disturbance with a cylindrical portion about a first axis transverse to an optical axis of the bandwidth narrowing module is superimposable on a wavefront of the laser beam;
the first optical component is pivotable about a pivoting axis parallel to the first axis;
the first optical component is pivotable about the pivoting axis relative to the second optical component; and
the second optical component is configured so that a wavefront disturbance produced by the first optical component is at least partially compensated.

2. The bandwidth narrowing module of claim 1, wherein the first optical component is a prism.

3. The bandwidth narrowing module of claim 2, wherein at least one surface of the prism has a cylindrical profile in at least some sections, and the at least one surface of the prism is selected an entrance surface of the prism, an exit surface of the prism, and a combination thereof.

4. The bandwidth narrowing module of claim 1, wherein the first optical component has a cylindrical form in at least in some sections, and the first optical component is between the beam expanding module and the reflection grating.

5. The bandwidth narrowing module of claim 4, wherein the first optical component is a cylindrical lens or a cylindrical mirror.

6. The bandwidth narrowing module of claim 5, wherein the second optical component is displaceable within the bandwidth narrowing module.

7. The bandwidth narrowing module of claim 5, wherein the second optical component is a prism.

8. The bandwidth narrowing module of claim 7, wherein at least one surface of the prism has a cylindrical profile in at least some sections, and the at least one surface of the prism is selected from the group consisting of an entrance surface of the prism, an exit surface of the prism, and a combination thereof.

9. The bandwidth narrowing module of claim 5, wherein the second optical component has a cylindrical form in at least some sections, and the second optical component is between the beam expanding module and the reflection grating.

10. The bandwidth narrowing module of claim 9, wherein the second optical component is a cylindrical lens or a cylindrical mirror.

11. The bandwidth narrowing module of claim 11, wherein the reflection grating is curved.

12. The bandwidth narrowing module of claim 11, further comprising a member configured to set a curvature of the reflection grating.

13. The bandwidth narrowing module of claim 1, wherein the first optical component is a first lens, and the second optical component is a second lens.

14. The bandwidth narrowing module of claim 1, wherein the first optical component is a prism, and the second optical component is a lens.

15. The bandwidth narrowing module of claim 1, wherein the first optical component is a first prism, and the second optical component is a second prism.

16. A laser light source comprising a bandwidth narrowing module according to claim 1.

17. The laser light of claim 16, wherein the bandwidth is adjustable in a range of approximately 100 fm to approximately 1000 fm.

18. A laser light source configured to emit light having a wavelength of from approximately 140 nm to approximately 380 nm, wherein the laser light source has a wavelength spectrum of a bandwidth around the wavelength, and the bandwidth is adjustable.

19. A laser light source configured to emit light having a wavelength and a wavelength spectrum of a bandwidth around the wavelength with a power of from approximately 20 to approximately 2000 watts, wherein the bandwidth is adjustable.

20. A laser light source configured to emit light pulses having a wavelength and having a wavelength spectrum of a bandwidth around the wavelength, wherein the light pulses have a power of from approximately 0.1 mJ/pulse to approximately 500 mJ/pulse, and the bandwidth is adjustable.
